(19) United States
(12) Patent Application Publication
(10) Pub. No.: US 2024/0105359 A1
(43) Pub. Date: Mar. 28, 2024

(54) BREAKAWAY MECHANISMS FOR CABLES

(71) Applicant: Hewlett-Packard Development Company, L.P., Spring, TX (US)

(72) Inventors: Owen Richard, Fort Collins, CO (US); Jon Anderson, Fort Collins, CO (US)

(73) Assignee: Hewlett-Packard Development Company, L.P., Spring, TX (US)

(21) Appl. No.: 17/768,902

(22) PCT Filed: Nov. 12, 2019
(86) PCT No.: PCT/US2019/060848

§ 371 Date: Apr. 14, 2022

(51) Int. Cl. H01B 7/18

(52) U.S. Cl. CPC H01B 7/1805

(57) ABSTRACT

In one example in accordance with the present disclosure, a device is described, which includes a first retainer to connect to a first section of a cable and a second retainer to connect to a second section of the cable. The first retainer and second retainer are connected together with a breakaway mechanism. The breakaway mechanism separates when tension is applied between the first section of the cable and the second section of the cable.

### BACKGROUND

Head-mountable displays are becoming increasingly widespread. Such head-mountable displays provide visual displays of information. In some examples, the display is correlated with the orientation of the head-mountable display such that when the user turns their head, the view changes to reflect the user's orientation.

### BRIEF DESCRIPTION OF THE DRAWINGS

The accompanying drawings illustrate various examples of the principles described herein and are a part of the specification. The illustrated examples do not limit the scope of the claims.

FIG. 1 is a block diagram of a device with a breakaway mechanism for a cable, according to an example of the principles described herein.

FIG. 2 is a block diagram of a device with a breakaway mechanism for a cable, according to another example of the principles described herein.

FIG. 3 shows a flow chart for a method, according to an example of the principles described herein.

FIG. 4 is a diagram of a device with a breakaway mechanism for a cable, according to an example of the principles described herein.

FIG. 5 is a diagram of a device with a breakaway mechanism for a cable, according to an example of the principles described herein.

FIG. 6 is a diagram of a device with a breakaway mechanism for a cable, according to an example of the principles described herein.

FIG. 7 is a diagram of a device with a breakaway mechanism for a cable, according to an example of the principles described herein.

FIG. 8 is a block diagram of a device with a breakaway mechanism for a cable, according to another example of the principles described herein.

FIG. 9 is a diagram of a device with a breakaway mechanism for a cable, according to an example of the principles described herein.

Throughout the drawings, identical reference numbers designate similar, but not necessarily identical, elements. The figures are not necessarily to scale, and the size of some parts may be exaggerated or minimized to more clearly illustrate the example shown. The drawings provide examples and/or implementations consistent with the description. However, the description is not limited to the examples and/or implementations shown in the drawings.

### DETAILED DESCRIPTION

Cables of various kinds are used to connect devices and systems. Cables allow the efficient and reliable transmission of power and information. One use of cables is in extended reality systems which provide visual and audio simulation of reality for a user. However, when cables are attached to moving objects, they have the potential for presenting various issues. For example, a cable may be pulled out of either of the devices it connects, which may lead to damage to the cable and/or connected devices. A cable pulling out as described may cause unexpected interruption of the activity being supported by the cable. This may cause user frustration.

Extended reality systems allow a user to become immersed in an enhanced reality environment wherein they can interact with the enhanced environment. Extended reality systems include virtual reality (VR) systems, augmented reality (AR) systems, and mixed reality (MR) systems. Such extended reality systems can include extended reality headsets to generate realistic images, sounds, and other human discernable sensations that simulate a user's physical presence in a virtual environment presented at the headset. A VR system may include physical spaces and/or multi-projected environments. AR systems may include those systems and devices that implement live direct and/or indirect displays of a physical, real-world environment whose elements are augmented by computer-generated sensory input such as sound, video, graphics and/or GPS data. MR systems merge real and virtual worlds to produce new environments and visualizations where physical and digital objects co-exist and interact in real time. For simplicity, VR systems, AR systems, and MR systems are referred to herein as extended reality (XR) systems.

In these systems, a cable may provide data for the headset. In some cases, the user is encouraged to move around in a physical space to interact with the simulated reality. This can present a challenge for cables connecting the XR headset to a computing system. For example, as a user moves about, they may get tangled in the cable, or may near the limit of the length of the cable.

The user may be less aware of the cable, and the available length, due to the lack of visual and/or audio feedback about the cable. That is, the user may move to the end of the cable without being aware that they have reached the limit of the cable. While the cable is fully extended, or nearly fully extended, a small or sudden movement may be enough to damage the cable and/or ports connected to the cable. In some instances, the cable pulls out from a port, terminating the flow of information and/or power over the cable to the VR headset. In other cases, the cable or the port is damaged from the tension applied to the cable. Similarly, unexpected tension or resistance on the cable may unbalance a user and cause injury, for example, by falling.

Described herein is a device to provide feedback, which may be tactile, visual, or auditory, to the user when nearing the end of the length of cable. The device includes two retainers attached to points on the cable so as to form a loop in the cable. The retainers are attached to each other. When force is applied to the cable that is above a threshold level, the retainers separate using a breakaway mechanism. This allows the loop of cable to extend the available cable. The force to activate the breakaway mechanism provides feedback to the user that the user is near the limit of the cable. The user may then take any number of remedial actions, such as stopping movement, moving toward the connection point of the cable, reattaching the breakaway mechanism, etc.

While useful for XR headsets where a user has limited visual interaction with the cable, the described devices may be useful for a variety of applications, including headphones, game controllers, power cords, intravenous (IV) lines, and any cable with an end attached to a moving device. The devices described herein may also be useful for cords, chains, etc. which do not carry an electrical signal and/or power. However, the ability of the devices to provide end of cable feedback without interrupting signal or power transmission makes the described devices useful on cords and cables for electronic devices. It is useful for the breakaway mechanism to activate without interrupting the flow of power and/or information provided by the cable.

As used herein in this specification and the associated claims, the term “cable” describes a line, cord, chain, cable, filament, tube, etc. which is used to connect two objects. In many examples, at least one of the two objects is intended to move with respect to the other object. A cable may be an insulated line which transmits power and/or data.

As used herein in this specification and the associated claims, the term “loop” describes a length of cable between the first retainer and second retainer which is released upon separation of the breakaway mechanism. In some examples, the cable forming the loop does not overlap. For example, the loop may be U-shaped, an oxbow, or otherwise shaped where the ends of the loop do not contact each other but instead the contact is made by the breakaway mechanism.

Among other examples, this specification describes a device including a first retainer to connect to a first section of a cable and a second retainer to connect to a second section of the cable. A breakaway mechanism connects the first retainer and the second retainer. The breakaway mechanism separates when tension is applied between the first section of the cable and the second section of the cable.

Among other examples, this specification also describes a device which includes a first retainer with a magnetic material. The first retainer connects to a first section of a cable. The device also includes a second retainer with a magnetic material. The second retainer connects to a second section of the cable. At least one of the magnetic materials is a magnet. The magnetic materials interact to provide feedback to the user when nearing a length limit of the cable.

This specification also describes a method of protecting a headset. According to the method, a first portion of a cable connected to the extended reality headset is retained in a first retainer and a second portion of the cable is retained in a second retainer. Upon a tensile force greater than a threshold being applied to the cable, the first and second retainers separate from each other.

Also described in this specification is a device including: a cable including: a first section, a second section, and a third section; wherein the second section is between the first section and third section. The cable also includes a first retainer integrally formed with the first section; and a second retainer integrally formed with the third section. The first and second retainers are coupled to one another via a breakaway mechanism that is to separate upon a predetermined force to extend a length of available cable.

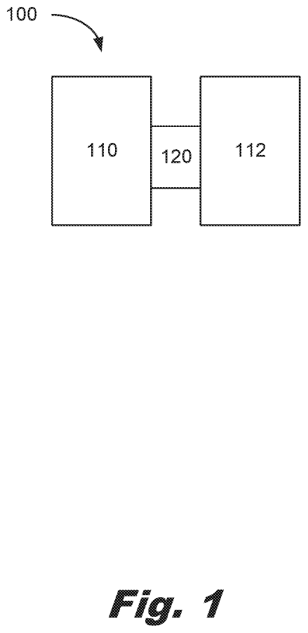

Turning now to the figures, FIG. 1 is a block diagram of a device (100) with a breakaway mechanism (120) for a cable, according to an example of the principles described herein. In general, the device (100) includes a first retainer (110) to connect to a first section of a cable and a second retainer (112) to connect to a second section of the cable. The device (100) also includes a breakaway mechanism (120) to connect the first retainer (110) and the second retainer (112). The breakaway mechanism (120) separates when tension is applied between the first section of the cable and the second section of the cable.

The retainers (110, 112) connect the device (100) to a cable and may have a variety of suitable shapes. In some examples, each retainer (110, 112) includes a channel to accommodate the cable. The channel may be ribbed to enhance the stability of the cable relative to the retainer (110, 112). That is, the ribs may interface with the cable in such a way as to prevent the cable from slipping through the retainers (110, 112). In some examples, the channel may be of uniform diameter. In other examples, the channel may have tapered ends and/or a strain relief on the end of the channel. A strain relief may be a conical opening at the end of the channel to increase the radius of curvature formed by the cable as it exits the retainers (110, 112).

In one example, the retainers (110, 112) include an arc-shaped channel to contain the cable. An arc-shaped channel may help align the portion of the cable and the retainers (110, 112) to provide a more repeatable separation force for the breakaway mechanism (120).

The retainers (110, 112) may be a molded plastic component. However, any suitable material may be used, with material selection depending, in part, on the breakaway mechanism (120) selected and the desired force to separate the breakaway mechanism (120). For example, the retainers (110, 112) may be formed of a plastic material and the breakaway mechanism (120) may be a set of plastic tabs which detach at a desired force. In this example, a retainer (110, 112) may flex under the force applied by the cable and that flexing may release the breakaway mechanism (120). This provides a length of cable that is not initially used for mobility but becomes available when the breakaway mechanism (120) separates the first retainer (110) from the second retainer (112).

The breakaway mechanism (120) separates when tension is applied by the cable to the first retainer (110) and the second retainer (112), for example, as a user wearing a XR headset walks away from a supporting computing device. That is, the cable extends as a user walks away from a stationary computing device. When the length of the cable is exhausted, the respective sections of the cable pull on the retainers (110, 112). The retainers (110, 112) may be pulled in opposing or oblique directions, causing the breakaway mechanism (120) to be separated. When the breakaway mechanism (120) separates, a length of cable between the first retainer (110) and second retainer (112) becomes available to provide slack to the cable. The force to activate the breakaway mechanism (120) provides tactile feedback to the user that the cable is near the end of its length. The feedback may alert a user, for example of an extended reality headset, to adjust their position to avoid overextending the cable or pulling the cable from its attachment points. Examples of attachment points include a cable connection to a head mounted display, a cable connection to a body pack, such as a device worn on the back or hip, a connection to a power source or adaptor, and/or a connection to a computer.

The breakaway mechanism (120) may be magnetic. For example, the retainers (110, 112) may have a magnet and/or magnetic material (e.g., iron) which are attracted to a respective component in the other retainer (110, 112).

The breakaway mechanism (120) may use other mechanical features to provide the attachment between the first retainer (110) and the second retainer (112). Examples of such features may include snaps, rivets, links, rings, hook and loop connectors, etc. In some examples, the breakaway mechanism (120) can be readily reattached after separation, for example by snapping the two retainers (110, 112) back together. Magnetic breakaway mechanisms (120) may be readily reattached without changes in an amount of force that activates the breakaway mechanism. In some examples, the breakaway mechanism (120) may be designed for one-time use and is designed to be replaced after separation.

In some examples, the breakaway mechanism (120) includes a plurality of attachments which separate under tension. For example, the breakaway mechanism (120) may include a set of snaps attaching the retainers (110, 112). The snaps may rely on different amounts of force to open them, from a low value to a high value. This may cause the snaps to release in series. Thus, a user may first be alerted via disconnection of a snap with a lower amount of force as a first stage and then be alerted during a second stage via disconnection of a breakaway mechanism (120) which disconnects under a larger force. Similarly, hook and loop connectors function as a set of small attachments between the two retainers (110, 112).

In some examples, the breakaway mechanism (120) may be adjustable to have different release thresholds. For example, if the breakaway mechanism (120) is a mechanical snap, one retainer (110) may include multiple locations to connect, where each location disconnects under a different amount of tension on the cable. Similarly, a hook and loop may be connectable over different lengths to produce different release forces.

In an example, the cable connects an extended reality headset to a port. The cable may be continuous, that is, without joints between the port and the headset. Such continuous cables have the potential to apply force to the port and/or headset when the limit of the cable is reached. The described device (100) provides a physical feedback to the user that they have reached the limit of the cable without overstressing the cable or implementing an additional joint. Such additional joints can decrease signal quality of information transmitted on the cable. Similarly, additional joints can come loose during use and interrupt activity. In contrast, the expansion of the cable from separation of the breakaway mechanism (120) does not introduce any elements into the information transmission of the cable, which may interrupt information transmission. Separation of the breakaway mechanism (120) does not disrupt power and/or information being transmitted along the cable.

The breakaway mechanism (120) may include connectors which connect to each other until force is applied above a threshold. When sufficient force is applied, the connectors separate as part of the breakaway mechanism (120) activation. Each connector may be associated with a retainer (110, 112).

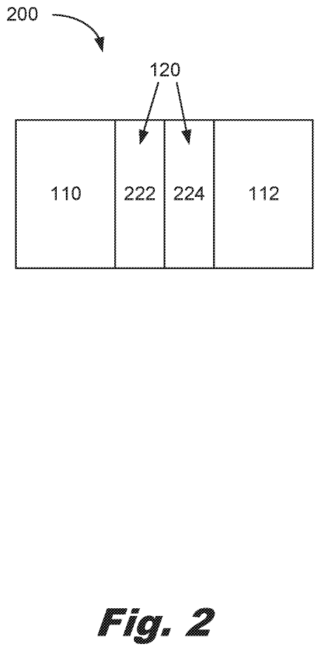

FIG. 2 is a block diagram of a device (200) with a breakaway mechanism (120) for a cable, according to an example of the principles described herein. The device (200) includes a first retainer (110) and a second retainer (112) to connect to different portions of a cable and form a loop, i.e., a length of cable between the first retainer (110) and second retainer (112). The retainers (110, 112) are connected by a magnetic breakaway mechanism (120) which is made of a magnet (222) and a piece of magnetic material (224). The magnet (222) may be affixed to the first retainer (110) and the magnetic material (224), which itself may be a magnet, is affixed to the second retainer (112). The attraction of the magnet (222) to the magnetic material (224) holds the breakaway mechanism (120) together until the applied force overcomes the magnetic attraction and the retainers (110, 112) separate from each other. In some examples, the magnet (222) induces magnetism in the magnetic material (224). In other examples, the magnetic material (224) is also a magnet.

The magnet (222) and magnetic material (224) may be arranged to face each other when the breakaway mechanism (120) is in use. In some examples, the device (200) further includes a shroud. The shroud surrounds the surface of the magnet (222) and/or magnetic material (224) to limit lateral motion when the breakaway mechanism (120) is being separated. That is, during use and or re-attachment, the magnet (222) may not completely align with the magnetic material (224). Even in cases where initially the magnet (222) and the magnetic material (224) are aligned, during use they may become misaligned. Such misalignment may result in a breakaway at less than the predetermined threshold. For example, the magnet (222) and magnetic material (224) may become so misaligned that they eventually disconnect, even when not at the length limit of the cable. Accordingly, when disconnected, they do not provide the physical feedback to indicate a user has reached the end of the cable length. The shroud, by enveloping the interface between these components, prevents the likelihood of this misalignment. In other words, the shroud may ensure the separation force to separate the breakaway mechanism (120). In one example, the shroud may be a collar surrounding the magnet (222) and/or magnetic material (224). The shroud may be a set of pins and/or walls which limit lateral motion of the magnet (222) and/or magnetic material (224). In an example, each connecting component, i.e., the magnet (222) and magnetic material (224), has a shroud which interdigitate with the corresponding shroud on the other retainer (110). In other examples, the shroud may be coupled to just one of the connecting components, yet may encompass the other connecting component when the retainers (110, 112) are joined.

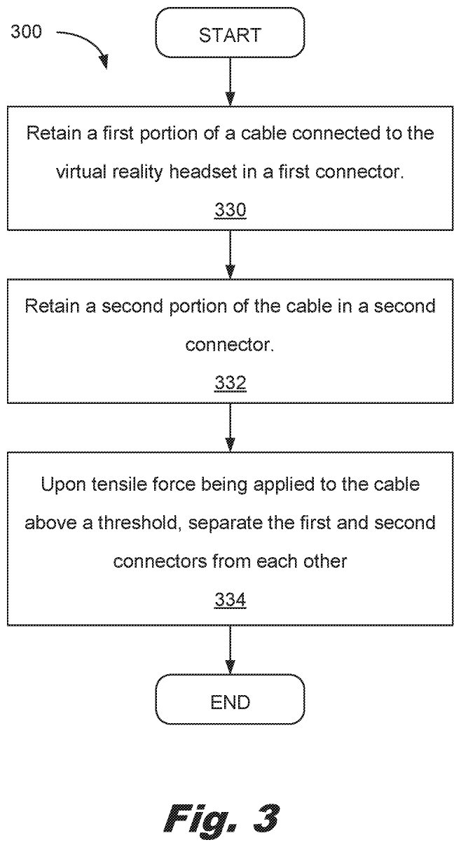

FIG. 3 shows a flowchart for a method (300) consistent with the present specification. According to the method (300), a first portion of a cable connected to the extended reality headset is retained (block 330) in a first retainer (FIG. 1, 110). In some examples, the cable is retained in a channel in the first retainer (FIG. 1, 110), which channel may include ribs to secure the cable in place. The retainer (FIG. 1, 110) may include a cap to cover the channel. For example, the retainer may be formed from two pieces, a first piece which includes the channel and a second piece, the cap, which snaps into place over the channel to secure the cable in place. The cap may be connected to the first piece by a tether. This approach allows a user to readily add the device (FIG. 1, 100) to an existing cable. In other examples, the channel has an open top. For example, the ribs may be sufficient to retain the cable in the channel without a cap.

According to the method (300), a second portion of the cable is retained (block 332) in a second retainer (FIG. 1, 112). In some examples, the first retainer (FIG. 1, 110) and second retainer (FIG. 1, 112) are symmetrical and/or identical. In other examples, the first retainer (FIG. 1, 110) and second retainer (FIG. 1, 112) have different designs. For example, one retainer (FIG. 1, 110) may be designed to interface with a port or similar component at an end of the cable.

According to the method, upon a tensile force greater than the threshold being applied to the cable, the first and second retainers (FIG. 1, 110, 112) are separated (block 334) from each other. In an example, the threshold for separation is between 1 pound-force (lbf) and 9 lbf. The threshold may be between 3 lbf and 6 lbf, for example, the threshold may be about 4.5 lbf. Selection of a threshold may depend on the release force on the ends of the cable and/or when damage occurs to the cable or connections. Similarly, the threshold may be high enough to prevent inadvertent separation and to provide feedback to the user that the cable has separated.

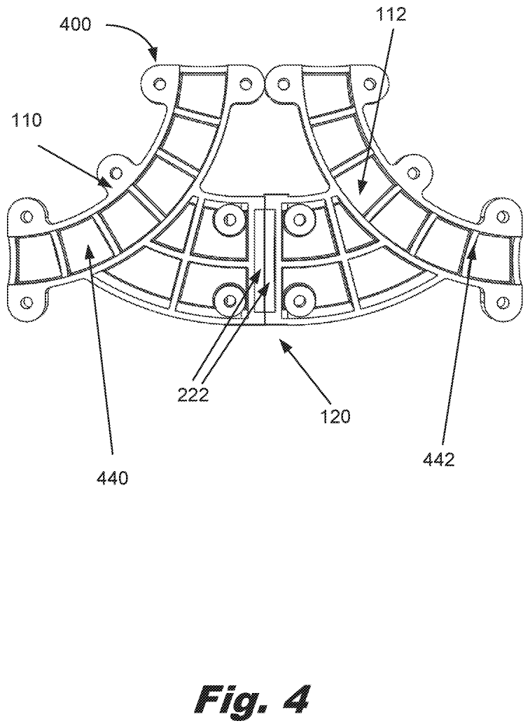

FIG. 4 is a diagram of a device (400) with a breakaway mechanism (120) fora cable, according to an example of the principles described herein. The device (400) includes a first retainer (110) and a second retainer (112). The first and second retainers (110, 112) are attached with a breakaway mechanism (120). In this device (400), the breakaway mechanism (120) includes two magnets (222) which hold the two retainers (110, 112) together.

As described above, the retainers (110, 112) may include an arc-shaped channel (440) to hold the cable. FIG. 4 also depicts the ribs (442) that may be formed in the channel (440) to retain the cable. The arc of the channel (440) helps to align the cable so the ends are pulling in tension to activate the breakaway mechanism (120). In some examples, the extending portions of the cable are coaxial with each other. This may improve the repeatability of the force to activate the breakaway mechanism (120).

The retainer (110, 112) may be made of two or more pieces which attached together to hold the cable in place. In an example, the two or more pieces may be attached with snaps or latches so as to be readily assembled without tools. In another example, the two or more pieces are attached with screws or other fasteners.

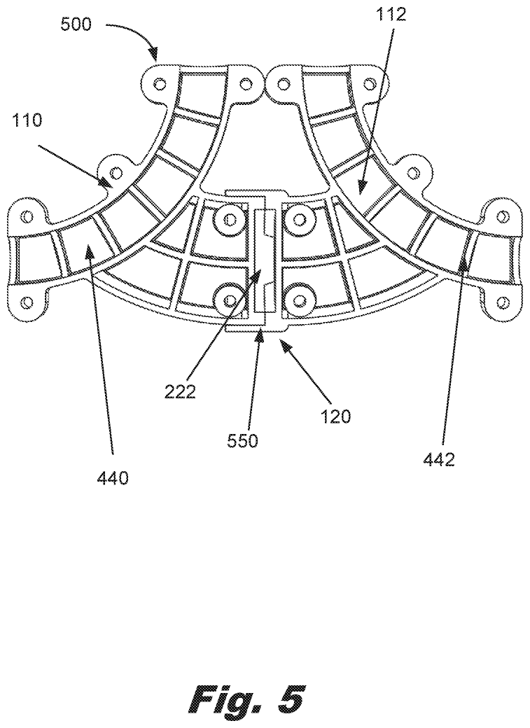

FIG. 5 is a diagram of a device (500) with a breakaway mechanism (120) for a cable, according to an example of the principles described herein. As in other examples, the device includes a first retainer (110) and a second retainer (112) which are attached with a breakaway mechanism (120). In this device (500), the breakaway mechanism (120) includes two magnets (222) which hold the two retainers (110, 112) together. In the example depicted in FIG. 5, the two retainers (110, 112) and breakaway mechanism (120) are enclosed in a shroud (550). The shroud (550) centers the breakaway mechanism (120) on each of the two retainers (110, 112) relative to each other. In some examples, the shroud (550) includes a collar around the magnets (222) such that when the breakaway mechanism (120) separates, it separates away from the other retainer (112). In contrast, without a shroud (550), in some instances, it is possible that the breakaway mechanism (120) will slide laterally relative to the magnets (222). This can cause release at a lower force threshold than is desired. That is, the two magnets (222) are surrounded by a shroud (550) which helps prevent lateral motion between the magnets (222) as they separate. This redirects the separation motion into the axis perpendicular to the faces of the magnets (222).

In some examples, the device (500) holds the cable in coaxial orientation on either side of the device (500). This is shown by the bottom openings in the retainers (110, 112) for the cable. This may help to provide consistency in the separation force of the breakaway mechanism (120).

The retainers (110, 112) also may contact each other near the other openings of the channel (440). This contact point may function as a fulcrum when the breakaway mechanism (120) opens which may provide greater reproducibility to the force to open the breakaway mechanism (120).

In an example, the device (500) includes a third retainer (110) connected with a second breakaway mechanism (120). The second breakaway mechanism (120) may have a different separation force than the first breakaway mechanism (120). In this manner, a set of stepped releases can be arranged to provide progressive feedback to a user while protecting the cable connections.

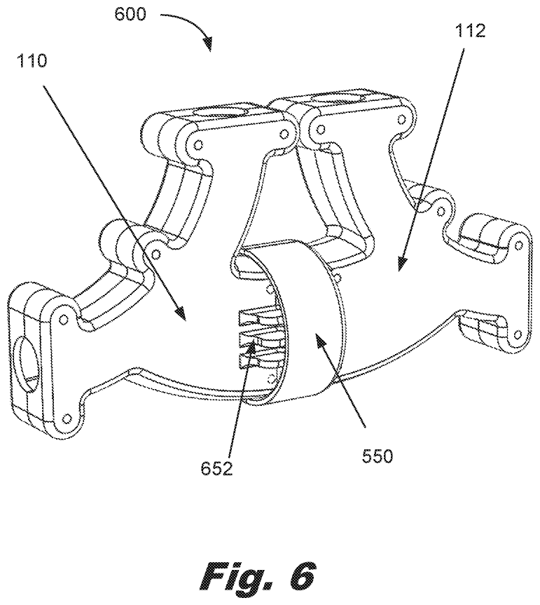

FIG. 6 is a diagram of a device (600) with a breakaway mechanism (120) for a cable, according to an example of the principles described herein. FIG. 6 depicts the shroud (550) which covers the breakaway mechanism (120). In some examples, the shroud (550) may be supported by supports (652). The supports (652) may help align the shroud (550) and may include ribs as seen in FIG. 6. The use of supports (652) may facilitate mold design for the retainers (110, 112), for example, by facilitating a smaller mold cavity. In some examples, the shroud (550) may include grooves and/or similar features to align with and/or interact with the supports (652).

FIG. 6 also depicts the two retainers (110, 112) which are formed from two pieces to create the channels (440). The channels (440) run from openings at the top of the retainers (110, 112) to openings at the side of the retainers (110, 112). In this example as depicted in others, the channels (440) have an arc-shaped path to provide a large bend radius for the cable placed in the channels (440). This may prevent local damage to the cable from kinking and/or similar sharp bends.

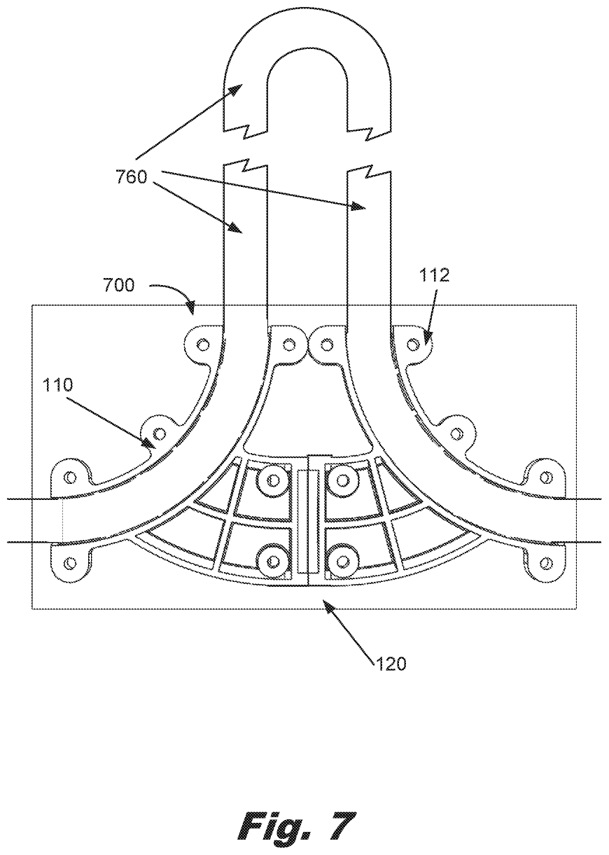

FIG. 7 is a diagram of a device (700) with a breakaway mechanism (120) fora cable (760), according to an example of the principles described herein. The device (700) has a cable (760) which enters into a channel (FIG. 4, 440) in a first retainer (110). The cable (760) exits the channel (440) and forms a loop, which as depicted in FIG. 7 is a U-shaped loop. The cable (760) then enters the second retainer (112) and passes through a second channel (FIG. 4, 440) before exiting the second retainer (112). When the ends of the cable (760) reach a predetermined tension, the breakaway mechanism (120) separates and the cable (760) in the loop becomes available, reducing the tension on the cable (760) without interrupting any power, communication, liquids, etc. that may be flowing through the cable (760).

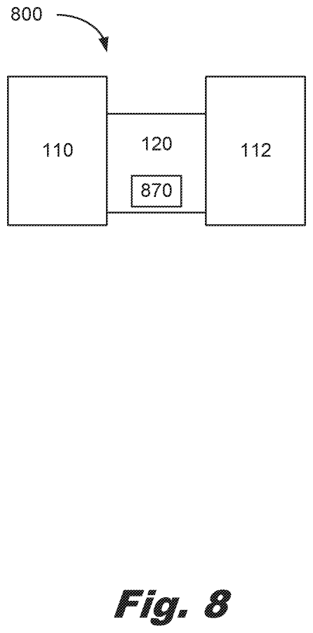

FIG. 8 is a block diagram of a device (800) with a breakaway mechanism (120), according to another example of the principles described herein. The device (800) includes a first retainer (110) and a second retainer (112) which are attached by a breakaway mechanism (120). In this example, the breakaway mechanism (120) includes a feedback mechanism (870) which detects separation of the breakaway mechanism (120).

In some examples, the feedback mechanism (870) may be powered and may include a local power source, such as a battery. In another example, the feedback mechanism (870) may receive power from the cable (FIG. 7, 760) or from a port and/or from a second cable.

Different types of feedback mechanisms (870) may be used to detect the separation of the breakaway mechanism (120). For example, a strain sensor may be used to monitor the force on the breakaway mechanism (120). In another example, a visual sensor, e.g., a camera, may detect when the breakaway mechanism (120) has separated.

In yet another example, a magnetic sensor may be used with a magnet (FIG. 2, 222) such that when the magnet (FIG. 2, 222) is removed, the feedback mechanism (870) indicates separation. An audio sensor may be used to detect a sound of the breakaway mechanism (120) separating. In one embodiment, the feedback mechanism (870) is a continuity sensor that is disrupted by activation of the breakaway mechanism (120). While particular reference is made to a few specific feedback mechanisms (870), a wide variety of sensor types may be used to detect the separation of the breakaway mechanism (120).

While specific reference is made to a tactile feedback as the components of the breakaway mechanism (120) physically separate, in some examples the device (100) may include an additional feedback mechanism to provide additional feedback to the user. For example, the feedback mechanism (870) may include a speaker and/or light source that, once triggered, generates a visual and/or audible indication of separation. In some examples, the feedback mechanism (870) may be electrically coupled to the headset and may provide the audible and/or visual feedback to the input devices in the XR headset, such as the screen and/or the speakers therein. In other examples, the feedback mechanism (870) may provide the alert to a computing device attached to the cable (FIG. 7, 760). Other signals may similarly be used to notify the user that the breakaway mechanism (120) has been activated.

In use, the feedback mechanism (870) detects the separation of the breakaway mechanism (120) and provides a notification to a user of the separation of the breakaway mechanism (120). In some examples, the notification is provided through the cable (760) attached to the first retainer (110) and second retainer (112).

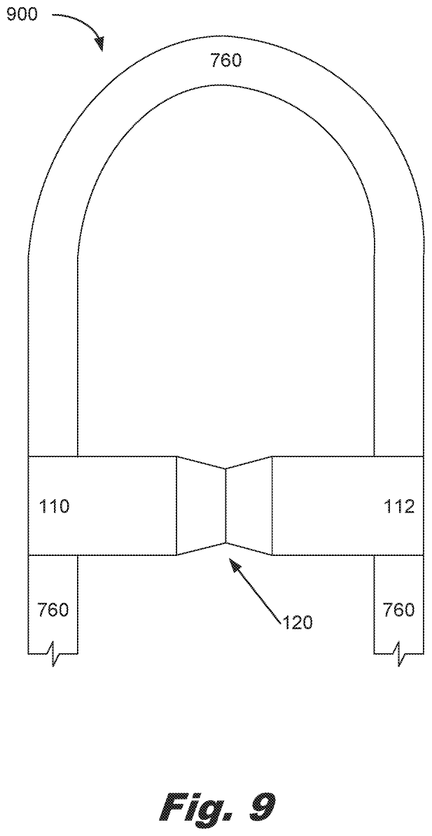

FIG. 9 is a diagram of a device (900) with a breakaway mechanism (120) fora cable (760), according to an example of the principles described herein. In this example, the device (900) includes a cable (760). The cable (760) is divided into a first section, a second section, and a third section, with the second section being between the first section and third section. The cable (760) also includes a first retainer (110) which is integrally formed with the first section of cable and a second retainer (112) which is integrally formed with the third section. The first retainer (110) and second retainer (112) are coupled to one another via a breakaway mechanism (120) that is to separate upon a predetermined force to extend a length of available cable (670). In some examples, the predetermined force is between 1 pound-force (lbf) and 9 lbf. The predetermined force may be between 3 lbf and 6 lbf. In one example, the predetermined force is about 4.5 lbf.

As described above, the breakaway mechanism (120) may be a mechanical breakaway mechanism (120). For example, the breakaway mechanism (120) may be a hook and loop connector. In other examples, the breakaway mechanism (120) may be of a different type of mechanical mechanism such as a mechanical snap, a clip, joint, or other connecting feature.

As described and depicted above, in other exmaples, the breakaway mechanism (120) may be magnetic. For example, the breakaway mechanism (120) may include two pieces of magnetic material including at least one magnet. The magnet induces magnetism in the magnetic material so that the breakaway mechanism (120) is held together until a threshold force is applied, separating the portions of the breakaway mechanism (120) from each other and allowing the length of cable (760) between the first retainer (110) and second retainer (112) to become available to reduce tension on the cable (670).

In some examples, the first retainer (110) and second retainer (112) may be fabric. For example, they may be fabric tags molded into the cable (670). This provides a strong mechanical bond to the cable (760). The fabric of the retainers (110, 112) may form a loop going around the cable (760). This allows the use of the tensile strength of the fabric rather than relying on the tear strength of the molding material to support the load on the cable (760) prior to separation of the breakaway mechanism (120).

It will be appreciated that, within the principles described by this specification, a vast number of variations exist. It should also be appreciated that the examples described are examples, and are not intended to limit the scope, applicability, or construction of the claims in any way.

What is claimed is:

1. A device comprising:
a first retainer to connect to a first section of a cable;
a second retainer to connect to a second section of the cable;
a breakaway mechanism to connect the first retainer and the second retainer, wherein the breakaway mechanism is to separate when tension is applied between the first section of the cable and the second section of the cable.

2. The device of claim 1, wherein the breakaway mechanism is a mechanical breakaway mechanism.

3. The device of claim 1, wherein an available length of cable between the first retainer and the second retainer becomes available to reduce tension on the cable when the breakaway mechanism separates.

4. The device of claim 1, wherein at least one retainer comprises a ribbed channel to retain the first section of the cable.

5. The device of claim 1, wherein the breakaway mechanism is a magnetic breakaway mechanism.

6. The device of claim 1, further comprising a feedback mechanism associated with the breakaway mechanism wherein the feedback mechanism is to provide audio or visual feedback to a user when the breakaway mechanism separates.

7. The device of claim 1, wherein the breakaway mechanism is adjustable with respect to an amount of force to separate the breakaway mechanism.

8. The device of claim 1, wherein the cable is an extended reality headset cable.

9. The device of claim 1, wherein the first retainer and second retainer define a loop of cable between them.

10. A device comprising:
a first retainer comprising a magnet, the first retainer to connect to a first section of a cable; and
a second retainer comprising a magnetic material, the second retainer to connect to a second section of the cable;
wherein the magnet interacts with the magnetic material to provide feedback to the user when nearing a limit of the cable.

11. The device of claim 10, wherein a first channel for the cable through the first retainer forms an arc and a second channel for the cable through the second retainer forms an arc.

12. The device of claim 10, further comprising a shroud surrounding the magnet, the shroud to reduce lateral motion of the magnet relative to the magnetic material.

13. The device of claim 10, wherein the cable is continuous from the first section of the cable through the second section of the cable.

14. A device comprising:
a cable comprising:
a first section, a second section, and a third section, wherein the second section is between the first section and third section;
a first retainer integrally formed with the first section; and
a second retainer integrally formed with the third section, wherein the first and second retainers are coupled to one another via a breakaway mechanism that is to separate upon a predetermined force to extend a length of available cable.

15. The device of claim 14, wherein the breakaway mechanism separates under a force between 1 and 9 pounds-force.
